(19) United States
(12) Patent Application Publication
(10) Pub. No.: US 2003/0039037 A1
(43) Pub. Date: Feb. 27, 2003

(54) Shopping cart magnifier (E-Z reader)

(76) Inventors: Thomas Miranda, Easthampton, MA (US); Jonathan Roche, Ashfield, MA (US); Randolph Duso, Northfield, MA (US); David Kroll, Westfield, MA (US)

Correspondence Address: Thomas A. Miranda, 67 Division Street, Easthampton, MA, 01027, US

(21) Appl. No.: 10/232,482

(22) Filed: Aug. 31, 2002

Related U.S. Application Data
(63) Continuation-in-part of application No. 09/727,894, filed on Dec. 1, 2000, now Pat. No. 6,441,974.

(51) Int. Cl. G02B 7/02

(52) U.S. Cl. 359/811

(57) ABSTRACT

Disclosed is a magnifying device mounted on the handle of a shopping cart. The present invention is intended to make it easier for people to read while shopping. Also disclosed are numerous means for attaching the device to the shopping cart handle, an adjustable supporting structure allowing the magnifier to be held in a variety of orientations, a two-part supporting structure for temporarily removing the magnifier from the handle attachment, and a light for illuminating the field of view of the magnifier.

### CROSS-REFERENCE TO RELATED APPLICATIONS:

This application is a continuation of pending application Ser. No. 09/727,894 filed on Dec. 1, 2000 by Miranda, et al., entitled “Shopping cart magnifier (E-Z Reader).” claim 1 of the present invention is identical with claim 1 in the pending application, with the exception that “means for attachment” has been substituted for “means of attachment.”

### STATEMENT REGARDING FED SPONSORED R&D

None

### REFERENCE TO SEQUENCE LISTING, A TABLE OR COMPUTER PROGRAM LISTING APPENDIX

None

### BACKGROUND OF THE INVENTION

Many people find it difficult to read fine print on packaging while shopping—for example, prices, ingredients, instructions, or nutrition information. The ability to read packages easily while shopping is useful for people concerned with drug interactions, allergic reactions, and health conditions related to nutrition. Many people, especially as they grow older, experience visual impairment, including poor near vision and poor vision in dim light. Corrective lenses used in everyday activities often are not adequate to read small print on packages. Hand-held magnifiers fully occupy one hand while being used and are only available for immediate use while in the hand. Using one to read an ingredients label requires two hands, one for the package and one for the magnifier. These limitations can be inconvenient for the shopper, especially if (s)he has weak hands or uses a cane or walker, if (s)he is juggling other items, if the store is crowded, if the cart is heavy, or if there are other difficult circumstances.

One solution for this problem is to have magnifying devices conveniently available while shopping. Additional light would also be useful. In the prior art, numerous devices exist to assist people with low vision, but few are designed specifically for the shopping environment.

U.S. Pat. No. 5,113,289 to Soper, No. 5,245,477 to Nyman, No. 5,926,315 to McBride, and 6,137,639 to Woolwine disclose various options for mounting magnifiers on store shelves. At fixed heights and locations, such devices are not necessarily convenient for any particular shopper at any particular time. They also create clutter and obstructions. Furthermore, they are easily overshadowed, which dims light for reading.

The present invention integrates a magnifying device with a shopping cart, allowing the shopper to use it conveniently anywhere in a store. It provides numerous alternative means for attachment to the shopping cart to accommodate various user preferences. Some users, such as store managers, might prefer to attach the devices permanently or semi-permanently to carts. Other users, such as individual shoppers, might prefer means for attachment that allow the device to be removed. An adjustable supporting structure allows the magnifier to be held in a variety of positions. A two-part supporting structure allows the magnifier to be temporarily removed from the shopping cart, used as a hand-held magnifier for examining shelf tags, and returned to the cart. A light illuminates the field of view.

Applicants are unaware of any prior art that mounts a magnifier on a shopping cart. There are no such known products in the commercial market serving low-vision people. Two previous patents, U.S. Pat. Nos. 5,847,883 to Rispoli, Sr. and 2,795,997 to Allen, disclose adjustable holders for magnifiers but fail to teach or fairly suggest means for attachment suitable for a shopping cart handle. All the alternative means for attachment in Rispoli, Sr. are single-point attachments suitable for curving or small structures such as a steering wheel. A shopping cart handle is straight and long, allowing the opportunity for a more stable attachment either at two points spaced apart or along some continuous length. In some cases, the weight of the magnifier and supporting structure might absolutely require such attachment means to hold the device steady. In addition, the flexible support structure of Rispoli, Sr. is not compatible with the shopping cart.

### SUMMARY OF THE INVENTION

The present invention relates to a magnifying device mounted on the handle of a shopping cart. It includes the following interrelated aspects and features:

A) A means for attachment to a shopping cart handle is intended to grip the cart handle firmly so as to hold the device in a convenient position. The preferred embodiment for the means for attachment would vary depending on the exact needs of the user. Many users would prefer that the means for attachment be provided by one or more clamps, which would allow quick installation which in many cases could be reversible. Others would prefer to use adhesive or screws, tacks, etc., either of which would serve as an inexpensive, relatively permanent mounting. Others would prefer to integrate the magnifier directly into the structure of the handle itself.

B) A supporting structure connects the magnifier with the means for attachment and is intended to hold the magnifier at a convenient angle for the user. In various embodiments, this structure could be made long or short, rigid or flexible, according to user preference. In the simplest embodiments described herein, the structure is short and rigid and consists of one section that connects to the means for attachment and another that frames a space sufficient to hold a magnifying device. Some people would prefer an embodiment of the supporting structure containing one or more articulated sections to allow the magnifier to be placed in a variety of positions and orientations. Some people would prefer an embodiment with a structure to allow the magnifier to be easily removed for hand-held use and then returned to its place. Some would prefer an embodiment that included a light to illuminate the magnifier's field of view.

C) A magnifying device is intended to allow the user to enlarge the images of items placed beneath it. In the preferred embodiment, this magnifying device consists of a refraction lens.

### BRIEF DESCRIPTION OF THE DRAWINGS

The figures described below each illustrate one or more particular claimed aspects of the present invention, as indicated by numbered arrows. Other elements not specifically indicated show various embodiments of aspects of the invention pertaining to claims other than those specifically illustrated by a particular figure.

FIG. 1 shows a perspective view of the present invention, illustrating the overall invention of claim 1, the clamps means for attachment of claim 2, and the fastening devices of claim 3.

FIG. 2 shows an edge view of a clamp, illustrating the interlocking structures of claim 4.

FIGS. 3 and 4 show an edge view and a perspective view, respectively, illustrating alternative embodiments of the tensioning devices of claim 5.

FIG. 5 shows a perspective view illustrating the casing of claim 6.

FIG. 6 shows two perspective views illustrating alternative embodiments of the set-screw assembly of claim 7.

FIG. 7 shows a perspective view illustrating the vice grips of claim 8.

FIG. 8 shows a perspective view illustrating the flexible material and attachment device of claim 9.

FIG. 9 shows a perspective view illustrating the adhesive substance of claim 10.

FIG. 10 shows an edge view illustrating the bolt of claim 11 and the resilient coating of claim 12.

FIG. 11 shows a cross sectional view illustrating the in-handle structures of claim 13 and the bolt of claim 11.

FIG. 12 shows a perspective view illustrating the integrated structure of claim 14.

FIG. 13 shows a perspective view illustrating the articulated section of claim 15

FIG. 14 shows a perspective view illustrating the two sections and interlocking structure of claim 16, the magnets of claim 17, and the tether of claim 18.

FIG. 15 shows a perspective view illustrating the light of claim 19.

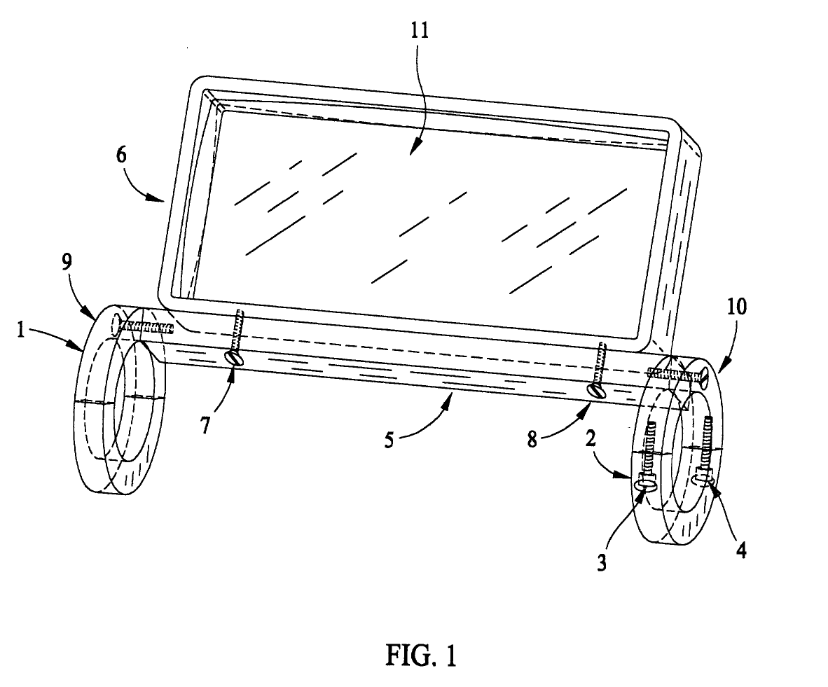

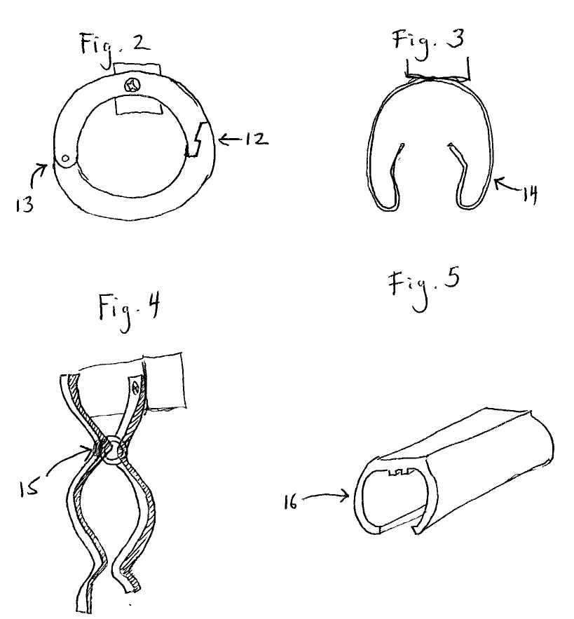

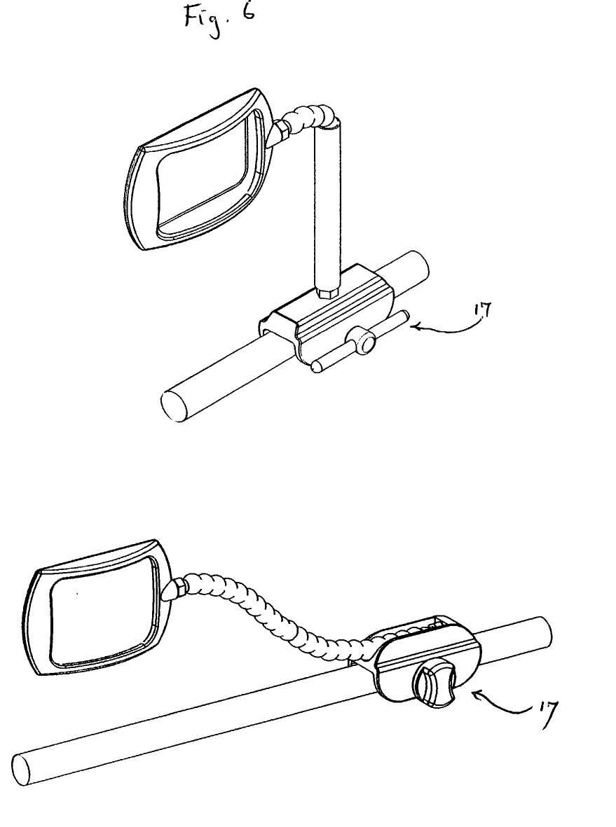

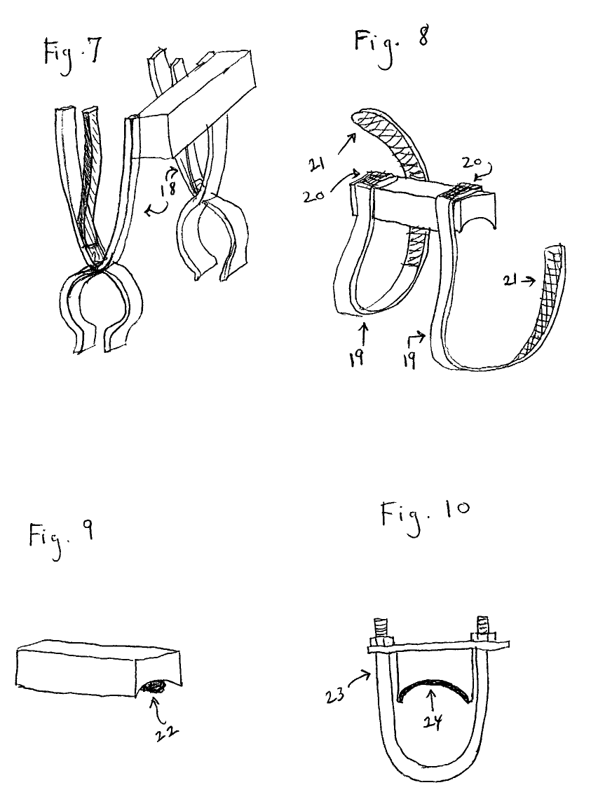

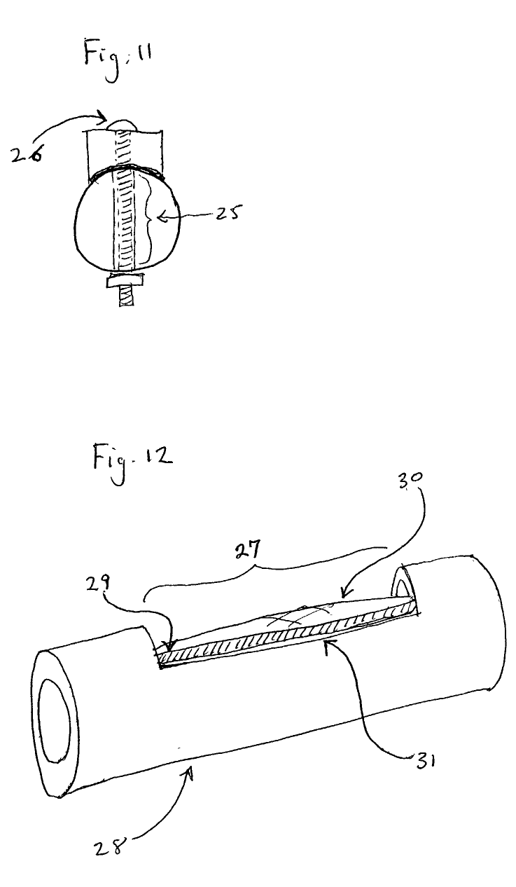

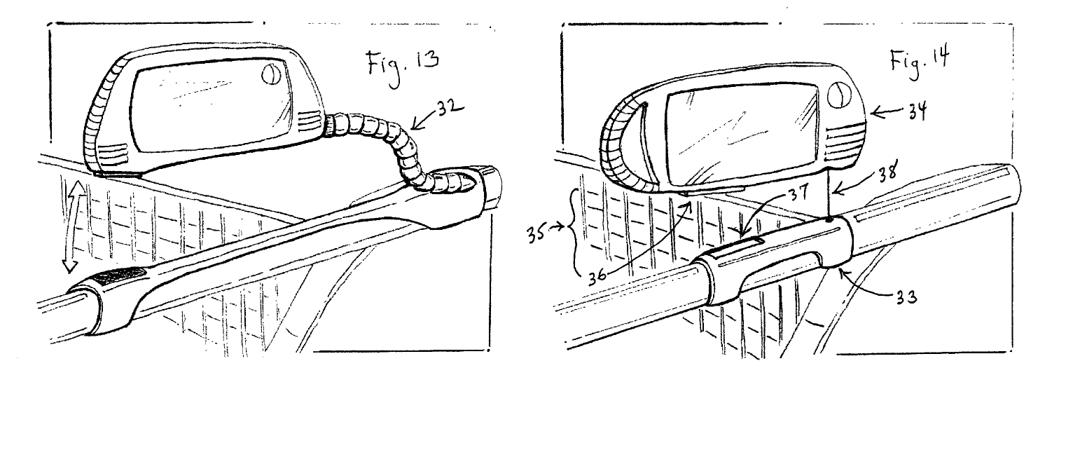

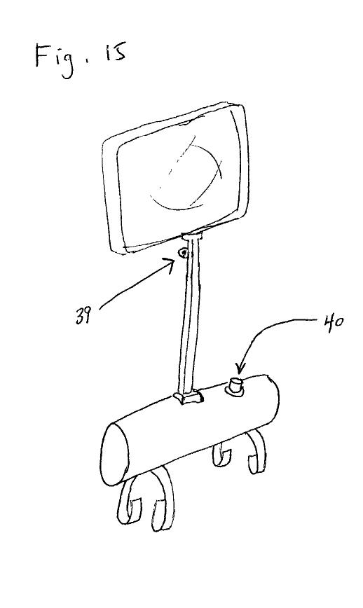

### DETAILED DESCRIPTION OF THE DRAWINGS

Different embodiments of the present invention would be preferred by different users according to their needs. In one embodiment, the means for attachment to the shopping cart handle consists of two pairs of semi-circular clamps (1, 2) fastened together in a fixed position with two screws (3, 4) per pair. The supporting structure consists of a rectangular bar (5) and a frame (6) attached to one another by means of two screws (7, 8). Screws (9, 10) attach each of said clamps to the ends of said bar. Said frame holds a magnifying device, which in this embodiment consists of a refraction lens (11).

There are numerous alternative embodiments of the clamp means for attachment, such as a clamp held in a fixed position by its own structures of snap-lock ends (12) and a hinge (13). Alternatively, the clamp can incorporate tensioning devices such as using a strip of flexible metal for the clamp's construction (14) or using a spring-clip device (15) to push the ends together. An approximately cylindrical casing can form a single long clamp, with tensioning forces provided by the resilience of a material such as plastic or metal and an opening along one side slightly smaller than the diameter of the handle, so that the entire structure snaps on lengthwise (16). A clamp's gripping force may be provided by a set-screw assembly (17) or vice grips (18). A clamp easily adaptable to various shopping cart handle dimensions can be made of a flexible material (19) to wrap around the handle and be secured by, for example, self adhesive surfaces (20, 21) such as Velcro.

In addition to the clamp means for attachment, there are other means as simple as a bead of glue (22) or a bolt, etc., such as, for example, the U-bolt illustrated (23). A resilient surface (24) on parts of the means for attachment which come in contact with the shopping cart handle enhances gripping performance by allowing the surfaces to conform more closely to one another under pressure.

It is also possible to incorporate structures within the shopping cart handle in the means for attachment, such as a drilled hole (25) to accept a bolt (26), stud, etc. One embodiment of the present invention integrates all its elements within the handle. For example, a rectangular hole (27) in a handle made of metal tubing (28) surrounds a frame (29) supporting the magnifier (30), with the means for attachment consisting of a bead of glue (31).

An articulated section (32) in the supporting structure allows the magnifier to be held in a variety of orientations. In order to facilitate hand-held use of the magnifier for reading shelf tags, etc., the supporting structure can be divided into two sections, an attachment section (33) and a magnifier section (34), with an interlocking structure (35) removably connecting the two sections. This interlocking structure may consist of two magnets (36, 37). A tether (38) between the two sections prevents the magnifier section from being left behind inadvertently.

Many users will prefer an embodiment which includes a light (39) to illuminate the magnifier's field of view. There are numerous ways to energize the light. In the embodiment illustrated, a push-button switch (40) connects the light with batteries (not shown) stored in the base of the supporting structure.

We claim:

1. A device to mount a magnifier on a shopping cart handle, comprising:
A. a means for attachment to the handle of a shopping cart;
B. a magnifier; and
C. a supporting structure connecting said means for attachment to said magnifier and holding said magnifier in a convenient position.

2. The device in claim 1, wherein said means for attachment comprises one or more clamps of suitable size and disposition to accept said shopping cart handle.

3. The device in claim 2, wherein said clamp(s) include fastening devices for holding said clamp(s) in one or more fixed positions.

4. The device in claim 2, wherein said clamp(s) include interlocking structures for holding said clamp(s) in one or more fixed positions.

5. The device in claim 2, wherein said clamp(s) include tensioning devices for applying gripping force to said shopping cart handle through a range of positions.

6. The device in claim 5, wherein said clamp comprises an approximately cylindrical casing with an opening along one length, and wherein said tensioning device consists in said casing being of suitable dimensions and material that said casing can slide over and snap onto said shopping cart.

7. The device in claim 2, wherein said clamp(s) include one or more set-screw assemblies for applying gripping force to said shopping cart through a range of positions.

8. The device in claim 2, wherein said clamp(s) include one or more vice grips.

9. The device in claim 2, wherein said clamp(s) consist of flexible material which wraps around said shopping cart handle and one or more attachment devices selected from the group consisting of buckles, snaps, and self-adhesive surfaces.

10. The device in claim 1, wherein said means for attachment includes an adhesive substance. (FIG. 8)

11. The device in claim 1, wherein said means for attachment includes one or more devices selected from the group consisting of screws, bolts, nails, tacks, and studs.

12. The device in claim 1, wherein the surface(s) of said means for attachment oriented towards said shopping cart handle include a resilient material of sufficient thickness and suitably positioned to conform to the exterior surfaces of said shopping cart handle.

13. The device in claim 1, wherein said means for attachment includes structures within said shopping cart handle.

14. The device in claim 13, wherein said means for attachment, supporting structure, and magnifier are integrated into a single structure.

15. The device in claim 1, wherein said supporting structure includes one or more articulated sections.

16. The device in claim 1, wherein said supporting structure comprises an attachment section, a magnifier section, and an interlocking structure removably connecting said magnifier section to said attachment section.

17. The device in claim 16, wherein said interlocking structure includes one or more magnets for connecting said magnifier and attachment sections.

18. The device in claim 16, wherein said supporting structure includes a tether between said attachment and magnifier sections.

19. The device in claim 1, wherein said supporting structure includes a light suitably disposed to illuminate the field of view of said magnifying device.
